(19) United States
(12) Patent Application Publication
(10) Pub. No.: US 2025/0355572 A1
(43) Pub. Date: Nov. 20, 2025

(54) ERASE AND WRITE OPERATIONS HAVING DIFFERENT CELL LEVELS

(71) Applicant: Microchip Technology Incorporated, Chandler, AZ (US)

(72) Inventors: Pitamber SHUKLA, San Jose, CA (US); Nian Niles YANG, Mountain View, CA (US); Achyut Chandulal Gedia, Los Gatos, CA (US); Tim James SYMONS, Anmore (CA)

(21) Appl. No.: 18/988,885

(22) Filed: Dec. 19, 2024

Related U.S. Application Data
(60) Provisional application No. 63/649,945, filed on May 20, 2024.

(51) Int. Cl. G06F 3/06

(52) U.S. Cl. CPC G06F 3/0619; G06F 3/0659; G06F 3/0679

(57) ABSTRACT

In some implementations, a storage device may perform an erase operation, associated with a first cell level, on a block based at least in part on a configuration to perform write operations on the block using a second cell level that is less than the first cell level. The storage device may perform the write operation after performing the erase operation. In some examples, the first cell level associated with the erase operation may be a triple-level cell (TLC) cell level and the second cell level may be a single-level cell (SLC). In other examples, the second cell level may be another cell level so long as the first cell level is higher (e.g., associated with carrying more bits per cell) than the second cell level.

### CROSS-REFERENCE TO RELATED APPLICATION

This patent application claims priority to Provisional Patent Application No. 63/649,945, filed on May 20, 2024, and entitled “ERASE AND WRITE OPERATIONS HAVING DIFFERENT ORDERS.” The disclosure of the prior Provisional patent application is considered part of and is incorporated by reference into this patent application.

### FIELD

The present disclosure generally relates to a storage device that is capable of performing operations using at least a first cell level and a second cell level. For example, the storage device may be capable of performing read/write operations using two or more of single-level cell (SLC), multi-level cell (MLC), triple-level cell (TLC), quad-level cell (QLC), or penta-level cell (PLC), among other examples. In some examples, the write operation may be associated with a power loss event or another circumstance where data is written from a volatile storage medium to a non-volatile storage medium.

### BACKGROUND

A storage device may include one or more storage media that may store and retain data without external power supply. One example of a storage device is a negative-and (NAND) flash memory device where the one or more storage media include one or more NANDs. The storage device may include non-volatile storage (e.g., NANDs) and volatile storage (e.g., double data rate (DDR) storage).

The storage device may store data as bits within the storage device (e.g., within the non-volatile storage). For example, the storage device may include transistors that store bit values. Transistors may store the bit values based on applying a voltage to an active area of the transistor, which voltage changes a state of the active area.

To read the data, the storage device may perform a read operation. The read operation may include applying a hard bit read voltage to the transistors and measuring (e.g., sensing) output voltages of the transistors. The output voltages of the transistors may be compared with a hard bit read voltage associated an cell level of a write operation. For example, the output voltage may be compared to a first set of read voltage thresholds associated with a first cell level (e.g., single-level cell (SLC)), a second set of read voltage thresholds associated with a second cell level (e.g., multi-level cell (MLC)), a third set of read voltage thresholds associated with a third cell level (e.g., triple-level cell (TLC)), a fourth set of read voltage thresholds associated with a fourth cell level (e.g., quad-level cell (QLC), or a fifth set of read voltage thresholds associated with a fifth cell level (e.g., penta-level cell (PLC)), among other examples, based at least in part on a cell level used for an associated write operation. Based at least in part on the comparison of the output voltage and a selected set of read voltages (e.g., selected based at least in part on an cell level used to write the data), the storage device may identify bit values of respective transistors.

If a hard bit decoding fails (e.g., based on a parity check or other indicator), the storage device may perform soft bit decoding. Soft bit decoding may involve an iterative process of testing different values for transistors associated with a read operation. For example, the controller may test a parity check when switching values from a “1” to a “0” or vice versa. The controller may switch values for output voltages (e.g., read voltages) that are within a threshold of the hard bit read voltage.

### SUMMARY

In some implementations, a method performed by a storage device includes performing an erase operation, associated with a first cell level, on a block based at least in part on a configuration to perform write operations on the block using a second cell level that is less than the first cell level. For example, the method may include performing a higher cell level erase function (e.g., a triple-level cell (TLC) erase) on a block before performing a lower cell level program or write operation (e.g., single-level cell (SLC) write) on the block. The method further includes performing the write operation after performing the erase operation.

In some implementations, a system comprises a controller, of a non-volatile memory device, to identify a block for programming using a first cell level. The controller is to perform an erase operation, having a second cell level that is greater than the first cell level, on the block based at least in part on the block being associated with programming using the first cell level. The controller is to perform a write operation using the first cell level after performing the erase operation.

In some implementations, a computer program product comprises one or more computer readable storage media and program instructions collectively stored on the one or more computer readable storage media. The program instructions comprise program instructions to perform an erase operation, having a first cell level, on a block associated with write operations having a second cell level that is less than the first cell level. The program instructions comprise program instructions to perform a write operation having the second cell level. The program instructions comprise program instructions to perform a read operation on the block using a threshold voltage that is associated with the first cell level, the second cell level, or a voltage that is between an erase voltage of the first cell level and an erase voltage of the second cell level.

### BRIEF DESCRIPTION OF THE DRAWINGS

FIGS. 1A-1B are diagrams of an example of using different cell level erase and write operations described herein.

FIGS. 2-3 are diagrams of example components of one or more devices used in conjunction with FIG. 1.

FIGS. 4-6 are flowcharts of example processes associated with using different cell level erase and write operations described herein.

### DETAILED DESCRIPTION

The following detailed description of example implementations refers to the accompanying drawings. The same reference numbers in different drawings may identify the same or similar elements.

A non-volatile memory device (e.g., a negative-and (NAND) memory device, also referred to as storage media) may store data that is accessible via a controller. The controller may include one or more of an application specific integrated circuit (ASIC) or firmware. In some examples, the storage media and the controller may be included in a storage device.

The storage device may also include volatile memory, such as double data rate (DDR) storage. In some cases, the storage device may attempt to write data from the volatile memory to the non-volatile memory. For example, the storage device may attempt to write data from the volatile memory to the non-volatile memory based at least in part on a loss of power. The storage device may use stored power (e.g., used for limited operations) to write the data from the volatile memory to preserve the integrity of the data.

The storage device may write data to the storage media, where the data is smaller than a full capacity of a storage medium (e.g., less than a fully programmed NAND block). This may result in a partially programmed storage medium (e.g., a partially programmed NAND block). The partially programmed storage medium may include a first portion that is programmed with bit values that represent the data, and a second portion that is left as “erase” values (e.g., an unprogrammed portion of the storage medium).

In a partially programmed storage medium, a first word line that includes data and is adjacent to a second word line that is unprogrammed may be prone to errors. For example, voltage may leak (e.g., along a bit line) from the first word line to the second word line. In this case, a string current or voltage of the first word line may be different from a third word line that includes data and is not adjacent to an unprogrammed word line. This difference may cause errors when reading the data of the first word line.

In some aspects described herein, a storage device may apply a first cell level when performing an erase operation on a portion of a storage medium and a second cell level when performing a write operation on the portion of the storage medium. Based at least in part on the second cell level being higher than the first cell level, the storage device may create an increased margin between an erase voltage of the first cell level and a program voltage of the second cell level. In this way, the storage device may reduce a likelihood of read errors based at least in part on writing a partially programmed storage medium.

In some aspects, the storage device may use different cell levels (e.g., associated with a programming scheme with different quantities of levels per cell or bits per read) for erase and write operations based at least in part on writing from the volatile storage to the non-volatile storage. For example, the storage device may perform a TLC-based erase operation on a storage medium before performing an SLC write operation on the storage medium, which may reduce errors when attempting to read data written during the SLC write operation. Based at least in part on using a higher cell level erase operation (e.g., a TLC-based erase operation) and a lower cell level write operation (e.g., an SLC-based write operation), the storage device may create a gap between a first voltage range of a first bit value associated with the erase operation (e.g., a bit value of {1}, {1,1}, {1,1,1}, or {1,1,1,1}, among other examples) and a second voltage range of a second bit value associated with a first programmed value (e.g., {0}, {1,0}, or {1,1,0}, among other examples) associated with the lower cell level write operation. The gap may improve a read/reliability margin, which may reduce an error rate that may have otherwise been caused by voltage leaking from a last programmed word line to a first unprogrammed word line of a partially programmed block.

In some aspects, the storage device using different cell levels for the erase and write operations on a portion of the storage medium (e.g., a block) may reduce errors that may have otherwise been caused by a partial block write operation (e.g., associated with a loss of power), where a last word line of the partial block write operation and a first word line upon resumption of writing to the block (e.g., adjacent to the last word line) have increased likelihood of errors.

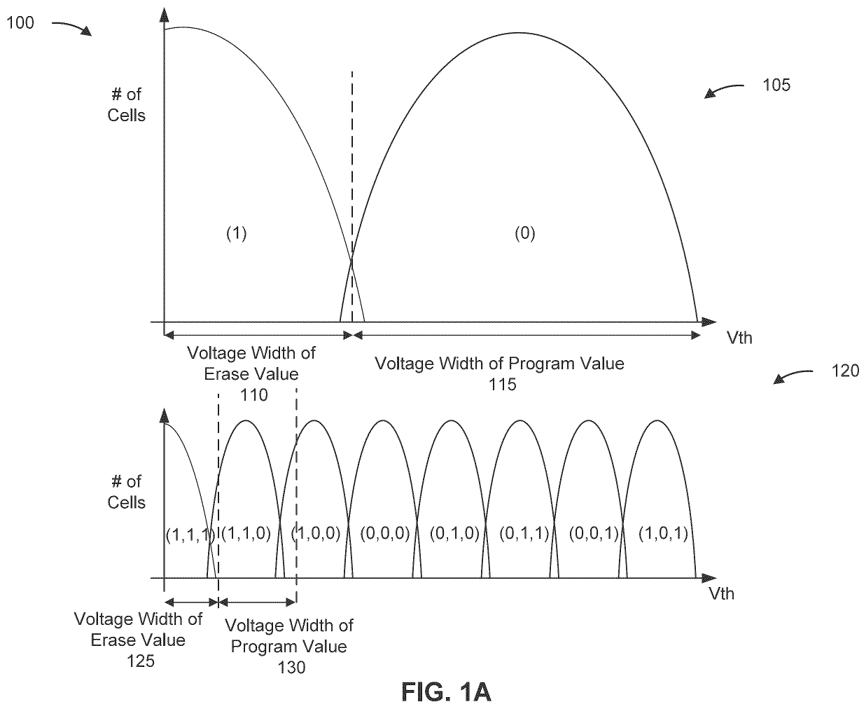

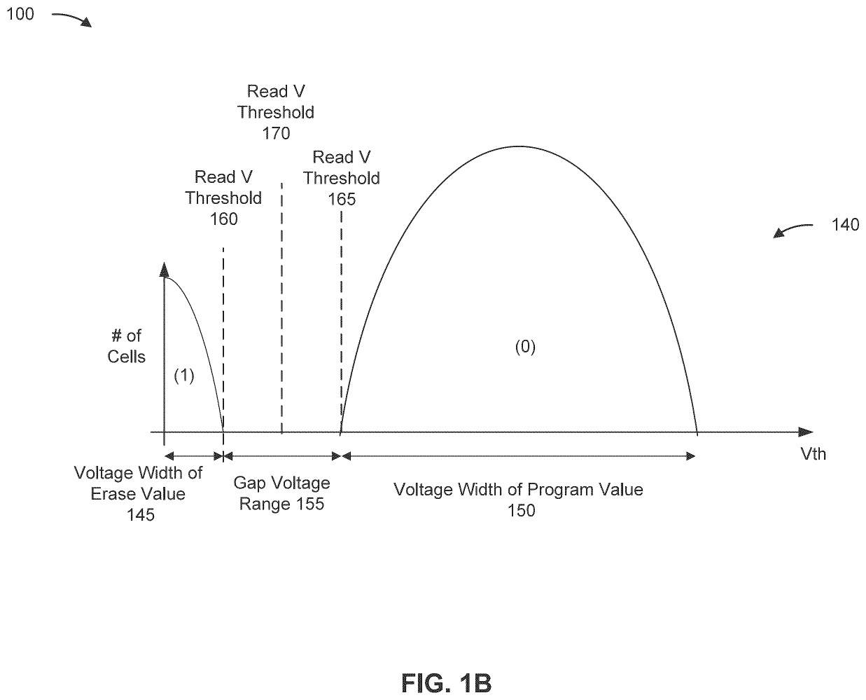

FIGS. 1A-1B are diagrams of an example 100 of using different cell level erase and write operations described herein. The operations described in connection with example 100 may be performed by a controller of a storage device. As described in context of at least FIG. 1, the storage device may include a non-volatile storage medium, such as a NAND device. In some aspects, the storage device may also include a volatile storage medium, such as a DDR device.

As shown in FIG. 1A, a first cell level program scheme 105 may include a voltage width 110 of an erase value and a voltage width 115 of a program value. As shown for illustrative purposes, the voltage width 110 may be associated with a bit value of 1 and the voltage width 115 may be associated with a bit value of 0 in an SLC scheme. In some examples, the first cell level program scheme 105 may include an MLC program scheme or a TLC program scheme, among other examples.

When writing data to a storage medium using the first cell level program scheme 105, the storage device may apply a voltage to cells of the storage medium to change voltages of the cells to a range associated with 0 or to leave the voltage of the cells in a range associated with 1. When performing an erase operation, the storage device may apply a voltage of to the cells of the storage medium to change any voltages associated with 0 to a voltage in the range associated with 1.

As also shown in FIG. 1A, a second cell level program scheme 120 may include a voltage width 125 of an erase value and a voltage width 130 of a program value. As shown for illustrative purposes, the voltage width 125 may be associated with a bit value of (1,1,1) and different ranges of voltages may be associated with different bit values, such as (1,1,0), (1,0,0), (0,0,0), (0,1,0), (0,1,1), (0,0,1), or (1,0,1) in a TLC scheme. In some examples, the second cell level program scheme 120 may include an MLC program scheme, a TLC program scheme, a QLC program scheme, or a penta-level cell (PLC) program scheme, among other examples. A cell level of the second cell level program scheme 120 may be greater than a cell level of the first cell level program scheme 105 (e.g., the first cell level may have more bits per memory cell than the second cell level).

When writing data to a storage medium using the second cell level program scheme 120, the storage device may apply a voltage to cells of the storage medium to change voltages of the cells to a range associated with a bit value other than the erase value or may apply or leave the voltage of the cells in a range associated with (1,1,1). When performing an erase operation, the storage device may apply a voltage to the cells of the storage medium to change any programmed voltages back to (1,1,1), or another erase value (e.g., with a number of bits associated with a cell level of the erase operation or associated write operation).

As shown in FIG. 1A, the voltage width 125 is narrower than the voltage width 110. Additionally, the voltage width 115 has a lower end value that is higher than a higher end value of the voltage width 125. In this way, a voltage associated with the erase value of the second cell level program scheme 120 does not overlap with a program value of the first cell level program scheme 105.

In some aspects, the storage medium may perform an erase operation using TLC parameters before programming with SLC parameters. Similarly, the storage medium may perform an erase operation using TLC parameters before programming with MLC parameters or perform an erase operation using MLC parameters before programming with SLC parameters. Additionally, or alternatively, the storage medium may perform an erase operation using QLC parameters before programming with TLC parameters. Other similar examples may be used.

In some examples, an erase upper tail will be tighter (e.g., narrower voltage range) for higher cell level program/erase schemes. For example, QLC is tighter than TLC, which is tighter than MLC, which is tighter than SLC. As in QLC, the storage medium may store 16 states (e.g., 4 bits), TLC stores 8 states (e.g., 3 bits), MLC stores 4 states (e.g., 2 bits), and SLC stores 2 states (e.g., 1 bit). In an example where data is to be written in SLC, the storage medium may use any available erase option, such as QLC, TLC, or MLC. Similarly, in an example, where data is to be written in MLC, the storage medium may use an erase operation having parameters of QLC or TLC, among other examples of higher cell level operations. In another example, where the data is to be written in TLC, the storage medium may use an erase operation having parameters of QLC, among other examples of higher cell level operations.

As shown in FIG. 1B, when an erase operation of the second cell level program scheme 120 and a write operation of the first cell level program scheme 105 are combined, a combined scheme 140 includes a voltage width 145 of an erase value (e.g., associated with the second cell level) and a voltage width 150 of a program value that are in ranges that are separated by a gap voltage range 155.

As described, the voltage width 145 may be based at least in part on parameters of a higher cell level erase operation (e.g., QLC, TLC, or MLC, among other examples). The gap voltage range 155 may be based at least in part on a difference in cell levels of the higher cell level erase operation and the lower cell level program value (e.g., a first programmed value) associated with the voltage width 150. For example, a sum of the voltage width 145 and the gap voltage range 155 may be based at least in part on a voltage width of an erase state associated with the lower cell level erase operation. In this way, the storage medium may configure a size of the gap voltage range 155 based at least in part on selection of the higher cell level erase operation.

The combined scheme 140 may be used to provide improved separation between voltage values that are to be read as a 1 or as a 0. This may reduce errors that may be otherwise caused by voltage leaking from a programmed word line to an unprogrammed word line of a partially programmed block, among other examples where an increased voltage margin may be helpful to reduce errors between an erase state and a first program state. For example, if a write command programs a cell with a voltage in the range associated with a 0 bit value, and voltage leaking occurs based at least in part on, for example, the cell including transistors in a word line that borders an unprogrammed portion of the partially programmed block, the voltage may decrease. When the storage device performs a read operation on the partially programmed block, a sensed voltage on the cell may be outside of the voltage range associated with the 0 bit value, but may be above the voltage width 145. In this case, the storage device may decode the bit value as a 0 based at least in part on the voltage value being above the voltage width 145, even though the voltage value is below the range associated with the bit value of 0. For example, the storage device may use a read voltage threshold 160 at an upper end of the voltage width 145 associated with the erase operation for the second cell level program scheme 120 for a read operation. Alternatively, the storage device may use a read voltage threshold 165 at the lower end of the voltage range associated with a bit value of 0 using the first cell level program scheme 105 for the read operation (e.g., with error correction applied after sensing). In another alternative, the storage device may use a read voltage threshold 170 that is between the upper end of the voltage width 145 associated with the erase operation for the second cell level program scheme 120 and the lower end of the voltage range associated with a bit value of 0 using the first cell level program scheme 105 (e.g., a midpoint or at a voltage value that is shifter toward the lower end or upper end of the gap voltage range 155). In some aspects, the storage medium may use the read voltage threshold 170 at a voltage that is non-overlapping with either of the voltage width 145 or the voltage width 150. For example, the read voltage threshold 170 may be at a voltage that is a midpoint of the gap voltage range 155 to create a largest possible gap with each of the voltage width 145 and the voltage width 150. In other examples, the read voltage threshold 170 may be closer to either of the voltage width 145 or the voltage width 150 based at least in part on a likelihood of a programmed value shifting up or down in voltage.

Based at least in part on using a first cell level scheme when performing an erase operation on a portion of a storage medium (e.g., the cells) and a second cell level when performing a write operation on the portion of the storage medium, and the second cell level being higher than the first cell level, the storage device may create an increased margin between an erase voltage of the first cell level and a program voltage of the second cell level. In this way, the storage device may reduce a likelihood of read errors.

The configurations and cell levels shown in FIG. 1 are provided as an example.

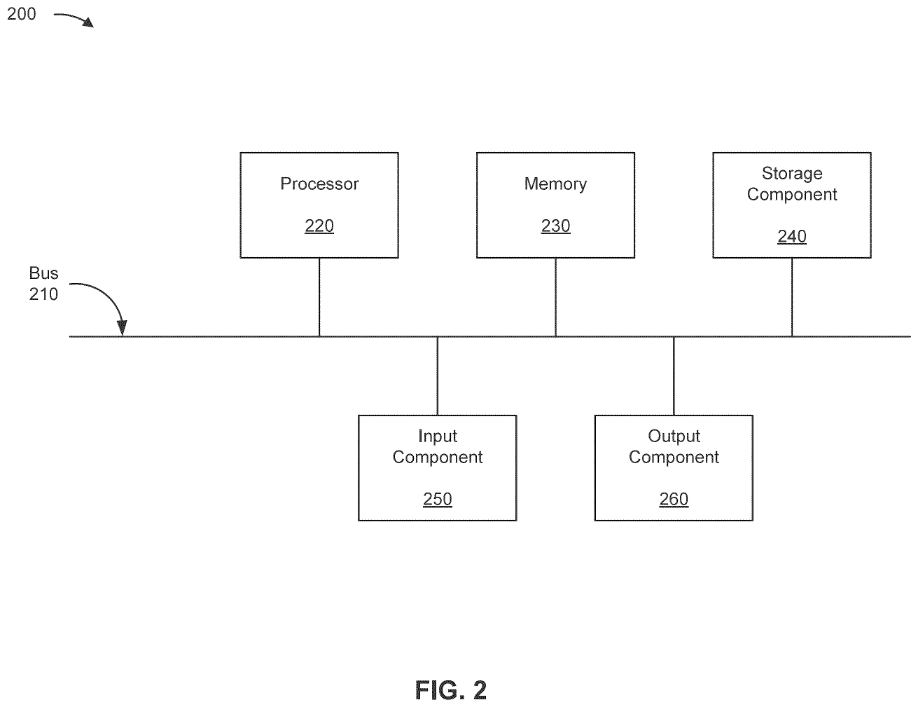

FIG. 2 is a diagram of example components of a device 200, which may correspond to one or more devices used in conjunction with FIG. 1, such as a computing system that includes, or is included in, a storage device or a host device. In some implementations, the storage device or the host device may include one or more devices 200 and one or more components of device 200. As shown in FIG. 2, device 200 may include a bus 210, a processor 220, a memory 230, a storage component 240, an input component 250, an output component 260, and a communication component 270. In some aspects, where the storage device comprises, or is comprised in device 200, the processor 220 may include a controller of the storage device, the memory 230 may include volatile storage media (e.g., DDR), the storage component 240 may include non-volatile storage media (e.g., NAND), the input component 250 may include a channel for receiving commands and data from a host device, and the output component 260 may include a channel for providing data to the host device.

Bus 210 includes a component that enables wired or wireless communication among the components of device 200. Processor 220 includes a central processing unit, a graphics processing unit, a microprocessor, a controller, a microcontroller, a digital signal processor, a field-programmable gate array, an application-specific integrated circuit, or another type of processing component. Processor 220 is implemented in hardware, firmware, or a combination of hardware and software. In some implementations, processor 220 includes one or more processors capable of being programmed to perform a function. Memory 230 includes a random access memory (RAM), a read only memory, or another type of memory (e.g., a flash memory, a magnetic memory, or an optical memory).

Storage component 240 stores data based at least in part on the data being written to the device 200 for non-volatile storage. For example, storage component 240 may include a NAND or another type of non-transitory computer-readable medium. Input component 250 enables device 200 to receive input, such as a command to perform a read/write/erase or program operation. Additionally, input component 250 may enable device 200 to receive data for storage on the storage component 240. Output component 260 enables device 200 to provide output, such as read data, to the host device.

Device 200 may perform one or more processes described herein. For example, a non-transitory computer-readable medium (e.g., memory 230 or storage component 240) may store a set of instructions (e.g., one or more instructions, code, software code, or program code) for execution by processor 220. Processor 220 may execute the set of instructions to perform one or more processes described herein. In some implementations, execution of the set of instructions, by one or more processors 220, causes the one or more processors 220 or the device 200 to perform one or more processes described herein. In some implementations, hardwired circuitry may be used instead of or in combination with the instructions to perform one or more processes described herein. Thus, implementations described herein are not limited to any specific combination of hardware circuitry and software.

In some aspects, processor 220 may perform a write operation on the storage component 240 based at least in part on receiving data and a command to write the data from the host device. Similarly, processor 220 may perform a read operation on the storage component 240 based at least in part on receiving a command to read data stored on the storage component 240 (e.g., previously written on the storage component 240). In some aspects, the processor 220 may perform an erase operation on the storage component 240 based at least in part on an internal operation of the storage device (e.g., based at least in part on a recycling operation or cleaning operation after relocating data between media of the storage component 240).

The device 200 may store data on the memory 230 before writing to the storage component 240. For example, the device 200 may store the data on the memory 230 until a full block of information is ready to be written on the storage component 240. Additionally, or alternatively, the device 200 may store lookup tables on the memory 230, such as a host logical address to flash logical address conversion table or a flash logical address to physical address conversion table. In this case, when the device 200 receives a command to read or write data, with the command identifying a host logical address associated with the data, the device 200 may identify a physical address of the storage component 240 to use for the read or write operation.

The number and arrangement of components shown in FIG. 2 are provided as an example. Device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

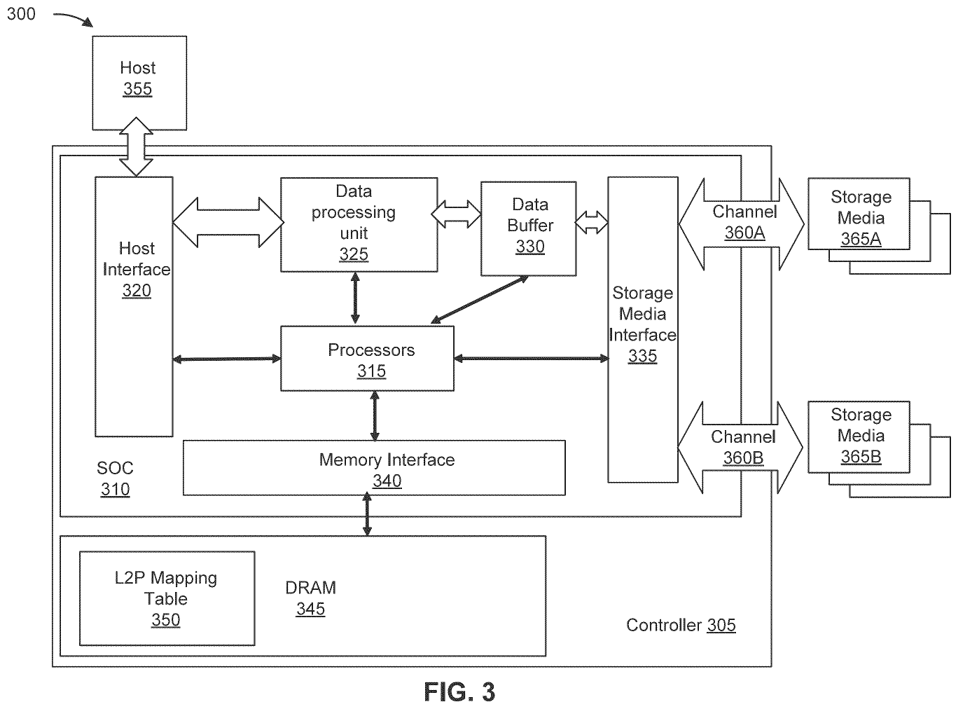

FIG. 3 is a diagram of example components of a storage device 300, which may correspond to one or more devices of FIGS. 1-2. In some implementations, the storage device 300 may include one or more devices 200 or one or more components of device 200. In some aspects, the device 200 may include one or more storage devices 300 or one or more components of storage device 300.

As shown in FIG. 3, the storage device 300 may include a controller 305 (e.g., an SSD controller). The controller 305 may include a system on chip (SOC) 310. The SOC 310 may perform computing or processing operations for the controller 305.

The SOC 310 may include one or more processors 315 that control, command, or observe operations at one or more other components of the SOC 310. The one or more processors 315 may be communicably coupled too one or more of a host interface 320, a data processing unit 325, a data buffer 330 a storage medium interface 335, or a memory interface 340.

The host interface 310 may be configured to communicate with a host device (e.g., host device 355 described below). The DPU 325 may manage data flow between the host interface 310 and storage media. The DPU 325 may further include a functional block that is responsible for managing data operations, such as reading, writing, error correction, or formatting. The DPU 325 may perform tasks such as page and block management (e.g., organization of data within storage media), bad block management, garbage collection, error correction and detection (e.g., using error correction codes or soft bit processing), data transformation (e.g., address mapping from host addresses to physical addresses, compression and decompression, or scrambling, among other examples), encryption and decryption, or power management associated with data operations, among other examples.

The data buffer 330 is a pipeline data buffer for the data transition. The data buffer 330 may include a temporary storage area used to transfer or process data between the storage media and a host system. The memory interface 340 is an interface between controller 310 and external DDR or DRAM, which may be used to temporarily hold the data. The memory interface 340 may provide an interface between the SOC 310 and the DRAM 345 to facilitate transfers of information. For example, the memory interface 340 may support requests to access a logical to physical (L2P) mapping table to identify a physical location of data requested by the host device, or to provide mapping information for storage in the L2P mapping table.

The controller 305 may further include DRAM 345. The DRAM 345 may locally store information that is available on demand at the controller 305 for operations of the controller 305. For example, the DRAM 345 may store an L2P mapping table 350 that maps logical locations of data and physical locations of data on connected storage media. In this way, the controller 305 may have access to mapping information for locating data on the connected storage media based at least in part on an indication associated with host data when written.

The host interface 320 may provide an interface for communicating with a host 355. For example, the host interface 320 may receive an access request or data for storage on connected storage media. In some aspects, the host interface 320 may provide data to the host after reading the data on from the connected storage media.

The storage media interface 335 may communicate via one or more channels 360 (e.g., 360A and 360B) with one or more connected storage media 365 (e.g., 365A and 365B). For example, the controller 305 may perform or initiate a read or write operation at a physical location of a storage media device 365.

Device 300 may perform one or more processes described herein. For example, a non-transitory computer-readable medium (e.g., memory 345 or storage component 365) may store a set of instructions (e.g., one or more instructions, code, software code, or program code) for execution by processor 315. Processor 315 may execute the set of instructions to perform one or more processes described herein. In some implementations, execution of the set of instructions, by one or more processors 315, causes the one or more processors 315 or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example.

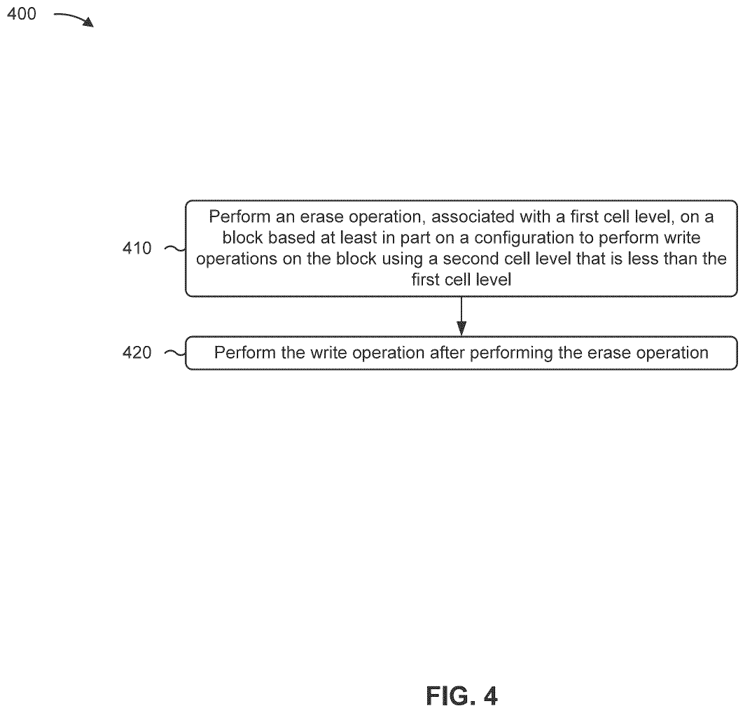

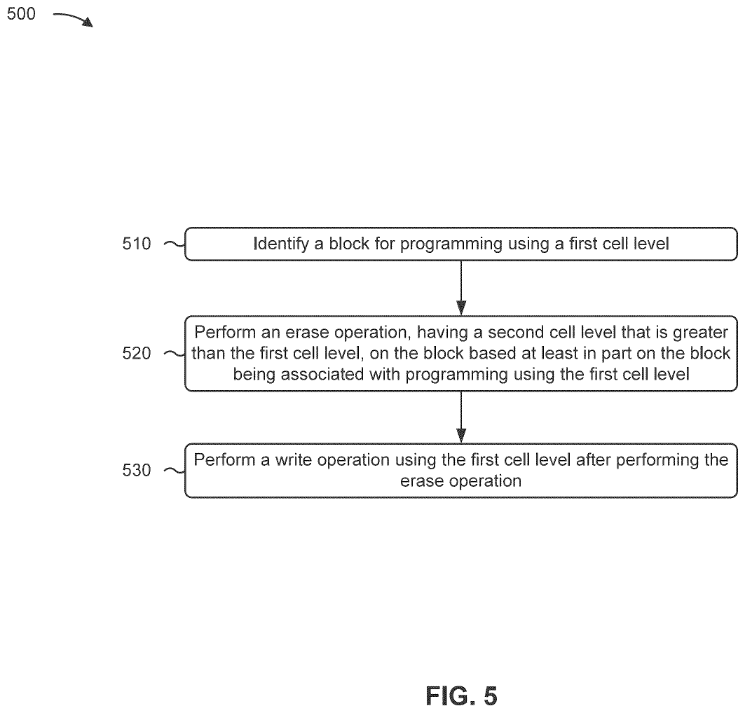

FIG. 4 is a flowchart of an example process 400 associated with erase and write operations having different cell levels described herein. In some implementations, one or more process blocks of FIG. 4 may be performed by a storage device (e.g., a controller or storage media of the storage device). In some implementations, one or more process blocks of FIG. 4 may be performed by another device or a group of devices separate from or including the storage device, such as a controller. Additionally, or alternatively, one or more process blocks of FIG. 4 may be performed by one or more components of device 200, such as processor 220, memory 230, storage component 240, input component 250, output component 260, and/or communication component 270. Additionally, or alternatively, one or more process blocks of FIG. 5 may be performed by one or more components of storage device 300, such as SOC 310, processors 315, media interface 335, or DRAM 345, among other examples.

As shown in FIG. 4, process 400 may include performing an erase operation, associated with a first cell level, on a block based at least in part on a configuration to perform write operations on the block using a second cell level that is less than the first cell level (block 410). For example, the storage device may perform an erase operation, associated with a first cell level, on a block based at least in part on a configuration to perform write operations on the block using a second cell level that is less than the first cell level, as described above.

As further shown in FIG. 4, process 400 may include performing the write operation after performing the erase operation (block 420). For example, the storage device may perform the write operation after performing the erase operation, as described above.

Process 400 may include additional implementations, such as any single implementation or any combination of implementations described below and/or in connection with one or more other processes described elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a flowchart of an example process 500 associated with erase and write operations having different cell levels described herein. In some implementations, one or more process blocks of FIG. 5 may be performed by a storage device (e.g., a controller or storage media of the storage device). In some implementations, one or more process blocks of FIG. 5 may be performed by another device or a group of devices separate from or including the storage device, such as a controller. Additionally, or alternatively, one or more process blocks of FIG. 5 may be performed by one or more components of device 200, such as processor 220, memory 230, storage component 240, input component 250, output component 260, and/or communication component 270. Additionally, or alternatively, one or more process blocks of FIG. 5 may be performed by one or more components of storage device 300, such as SOC 310, processors 315, media interface 335, or DRAM 345, among other examples.

As shown in FIG. 5, process 500 may include identifying a block for programming using a first cell level (block 510). For example, the storage device may identify a block for programming using a first cell level, as described above.

As further shown in FIG. 5, process 500 may include performing an erase operation, having a second cell level that is greater than the first cell level, on the block based at least in part on the block being associated with programming using the first cell level (block 520). For example, the storage device may perform an erase operation, having a second cell level that is greater than the first cell level, on the block based at least in part on the block being associated with programming using the first cell level, as described above.

As further shown in FIG. 5, process 500 may include performing the write operation after performing the erase operation (block 530). For example, the storage device may perform the write operation after performing the erase operation, as described above.

Process 500 may include additional implementations, such as any single implementation or any combination of implementations described below and/or in connection with one or more other processes described elsewhere herein. In some aspects, the first cell level of process 500 may be SLC and the second cell level of process 500 may be TLC or another cell level that is higher than SLC. Alternatively, the first cell level may be MLC, TLC, or QLC, so long as the second cell level is higher than the first cell level (e.g., TLC, QLC, PLC, among other examples).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

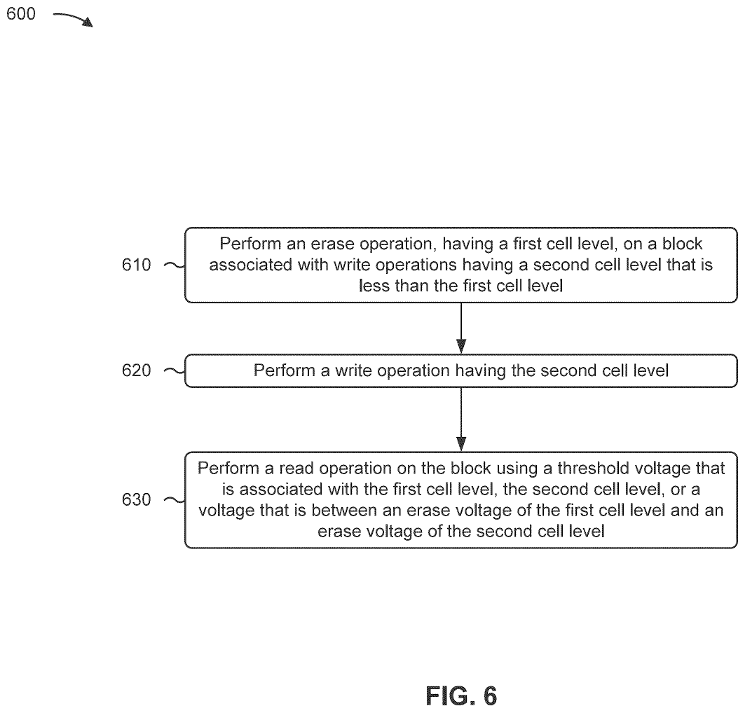

FIG. 6 is a flowchart of an example process 600 associated with erase and write operations having different cell levels described herein. In some implementations, one or more process blocks of FIG. 6 may be performed by a storage device (e.g., a controller or storage media of the storage device). In some implementations, one or more process blocks of FIG. 6 may be performed by another device or a group of devices separate from or including the storage device, such as a controller. Additionally, or alternatively, one or more process blocks of FIG. 6 may be performed by one or more components of device 200, such as processor 220, memory 230, storage component 240, input component 250, output component 260, and/or communication component 270. Additionally, or alternatively, one or more process blocks of FIG. 6 may be performed by one or more components of storage device 300, such as SOC 310, processors 315, media interface 335, or DRAM 345, among other examples.

As shown in FIG. 6, process 600 may include performing an erase operation, having a first cell level, on a block associated with write operations having a second cell level that is less than the first cell level (block 610). For example, the storage device may perform an erase operation, having a first cell level, on a block associated with write operations having a second cell level that is less than the first cell level, as described above.

As shown in FIG. 6, process 600 may include performing a write operation having the second cell level (block 620). For example, the storage device may perform a write operation having the second cell level, as described above.

As further shown in FIG. 6, process 600 may include performing a read operation on the block using a threshold voltage that is associated with the first cell level, the second cell level, or a voltage that is between an erase voltage of the first cell level and an erase voltage of the second cell level (block 630). For example, the storage device may perform a read operation on the block using a threshold voltage that is associated with the first cell level, the second cell level, or a voltage that is between an erase voltage of the first cell level and an erase voltage of the second cell level, as described above.

Process 600 may include additional implementations, such as any single implementation or any combination of implementations described below and/or in connection with one or more other processes described elsewhere herein.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

In a first implementation of any of processes 400-600, the first cell level is associated with a first quantity of bits per cell, wherein the second cell level is associated with a second quantity of bits per cell, and wherein the second quantity of bits per cell is less than the first quantity of bits per cell.

In a second implementation of any of processes 400-600, alone or in combination with the first implementation, the second cell level is associated with a single-level cell (SLC), a multi-level cell (MLC), a triple-level cell (TLC), or a quad-level cell (QLC), and wherein the first cell level is associated with an MLC, a TLC, a QLC, or a penta-level cell.

In a third implementation of any of processes 400-600, alone or in combination with one or more of the first and second implementations, the second cell level has at least two fewer bits per cell than the first cell level.

In a fourth implementation of any of processes 400-600, alone or in combination with one or more of the first through third implementations, the second cell level is associated with a single-level cell (SLC), and wherein the first cell level is associated with a triple-level cell (TLC).

In a fifth implementation of any of processes 400-600, alone or in combination with one or more of the first through fourth implementations, the block write operation is associated with one or more of a power loss event, writing data from a volatile medium of the storage device to a non-volatile medium of the storage device, or a partial block write operation.

In a sixth implementation of any of processes 400-600, alone or in combination with one or more of the first through fifth implementations, a first portion of the block having data written thereon is electrically coupled to a second portion of the block that is unprogrammed via bit lines.

In a seventh implementation of any of processes 400-600, alone or in combination with one or more of the first through sixth implementations, of any of processes 400-600 includes sensing voltage values of cells of the block having data written thereon, and applying a first read voltage threshold associated with the first cell level, a second read voltage threshold associated with the second cell level, or a third read voltage threshold that is between the first read voltage threshold and the second read voltage threshold.

While the foregoing examples have been described with respect to NAND flash memory device, implementations described therein may applicable devices that may need the error code comparison with addressable locality can be applied to. For example, implementations described herein may be applicable to a hard disk drive (HDD) or NOR flash device, or RAM, imaging sensor, graphic chip (e.g., graphical processing unit (GPU)), where the addressing is applied.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the implementations. Thus, the operation and behavior of the systems or methods are described herein without reference to specific software code—it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a storage device, the method comprising:
performing an erase operation, associated with a first cell level, on a block based at least in part on a configuration to perform write operations on the block using a second cell level that is less than the first cell level; and
performing the write operation after performing the erase operation.

2. The method of claim 1, wherein the first cell level is associated with a first quantity of bits per cell,
wherein the second cell level is associated with a second quantity of bits per cell, and
wherein the second quantity of bits per cell is less than the first quantity of bits per cell.

3. The method of claim 2, wherein the second cell level is associated with a single-level cell (SLC), a multi-level cell (MLC), a triple-level cell (TLC), or a quad-level cell (QLC); and
wherein the first cell level is associated with an MLC, a TLC, a QLC, or a penta-level cell.

4. The method of claim 2, wherein the second cell level has at least two fewer bits per cell than the first cell level.

5. The method of claim 1, wherein the second cell level is associated with a single-level cell (SLC); and
wherein the first cell level is associated with a triple-level cell (TLC).

6. The method of claim 1, wherein the block write operation is associated with one or more of:
a power loss event,
writing data from a volatile medium of the storage device to a non-volatile medium of the storage device, or
a partial block write operation.

7. The method of claim 1, wherein a first portion of the block having data written thereon is electrically coupled to a second portion of the block that is unprogrammed via bit lines.

8. The method of claim 1, comprising performing a read operation on the block, the read operation comprising:
sensing voltage values of cells of the block having data written thereon; and
applying a first read voltage threshold associated with the first cell level, a second read voltage threshold associated with the second cell level, or a third read voltage threshold that is between the first read voltage threshold and the second read voltage threshold.

9. A system comprising:
a controller, of a non-volatile memory device, to:
identify a block for programming using a first cell level;
perform an erase operation, having a second cell level that is greater than the first cell level, on the block based at least in part on the block being associated with programming using the first cell level; and
perform a write operation using the first cell level after performing the erase operation.

10. The system of claim 9, wherein the first cell level is associated with a first quantity of bits per cell,
wherein the second cell level is associated with a second quantity of bits per cell, and
wherein the second quantity of bits per cell is greater than the first quantity of bits per cell.

11. The system of claim 10, wherein the first cell level is associated with a single-level cell (SLC), a multi-level cell (MLC), a triple-level cell (TLC), or a quad-level cell (QLC); and
wherein the second cell level is associated with an MLC, a TLC, a QLC, or a penta-level cell.

12. The system of claim 10, wherein the first cell level has at least two fewer bits per cell than the first cell level.

13. The system of claim 9, wherein the first cell level is associated with a single-level cell (SLC); and
wherein the second cell level is associated with a triple-level cell (TLC).

14. The system of claim 9, wherein the write operation is associated with a power loss event.

15. The system of claim 9, wherein the write operation is associated with writing data from a volatile medium of the storage device to a non-volatile medium of the storage device.

16. The system of claim 9, wherein to the controller is to perform a read operation on the block, the read operation comprising:
sensing of voltage values of cells of the block having data written thereon; and
application of a first read voltage threshold associated with the first cell level, a second read voltage threshold associated with the second cell level, or a third read voltage threshold that is between the first read voltage threshold and the second read voltage threshold.

17. The system of claim 9, wherein a first portion of the block having data written thereon is electrically coupled to a second portion of the block that is unprogrammed via bit lines.

18. A computer program product comprising:
one or more computer readable storage media, and program instructions collectively stored on the one or more computer readable storage media, the program instructions comprising:
program instructions to perform an erase operation, having a first cell level, on a block associated with write operations having a second cell level that is less than the first cell level;
program instructions to perform a write operation having the second cell level; and
program instructions to perform a read operation on the block using a threshold voltage that is associated with the first cell level, the second cell level, or a voltage that is between an erase voltage of the first cell level and an erase voltage of the second cell level.

19. The computer program product of claim 18, wherein the write operation is associated with writing data from a volatile medium of the storage device to a non-volatile medium of the storage device.

20. The computer program product of claim 18, wherein the write operation comprises a partial block write operation.
